(19) United States
(12) Patent Application Publication
(10) Pub. No.: US 2009/0266141 A1
(43) Pub. Date: Oct. 29, 2009

(54) Counter-Measure Expendable Load Simulator

(76) Inventor: Jackie Bryan Pratt, Leonardtown, MD (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(21) Appl. No.: 12/111,434

(22) Filed: Apr. 29, 2008

(51) Int. Cl. G01N 3/00

(52) U.S. Cl. 73/12.12

(57) ABSTRACT

A counter-measure expendable load simulator that includes a handle, a spring, a hammer and test recording equipment. The spring communicates with the handle, while the hammer communicates with the handle such that when the handle is engaged, the handle and hammer compresses the spring, and when the handle is released the spring expands and the spring drives the hammer into a dummy expendable such that the dummy expendable is impacted by the hammer. Test recording equipment records loads imparted by the hammer on the dummy expendable.

### STATEMENT OF GOVERNMENT INTEREST

The invention described herein may be manufactured and used by or for the Government of the United States of America for governmental purposes without payment of any royalties thereon or therefore.

### BACKGROUND

The present invention relates to a counter-measure expendable load simulator. More specifically, but without limitation, the present invention relates to a device that can simulate physical loads generated when a counter-measure is dispensed.

An expendable may be defined, but without limitation, as an item that is consumed or loses its identity, when used. Aerial expendables (expendables used in the air) are used for a variety of applications, including, but not limited to, illumination, signaling, marking, decoys, military counter-measures, and the like. When used by the military, specifically as counter-measures, the expendable can be dispensed or ejected from an aircraft or a dispenser. Because of the important role an expendable plays, especially in military operations, it is important that during an expendable dispense event the physical loads imparted upon the airframe do not result in a structural failure. It is important to test the structural integrity of an airframe under the conditions of expendable dispensing.

Current methods of testing and evaluating the effect of the physical loads imparted on airframes during the dispense of expendables often requires the use of pyrotechnics. Such testing typically can only be conducted in areas where pyrotechnics are allowed, and requires extensive involvement of various different type of personnel. Additionally, when using live pyrotechnics, test procedures that are necessary to ensure safe test conduct require much more time and effort to properly accomplish, and can significantly impact the time required to a test program.

For the foregoing reasons, there is a need for a system capable of reproducing the physical forces generated when an expendable is dispensed.

### SUMMARY

The present invention is directed to a counter-measure expendable load simulator that meets the needs enumerated above and below.

The present invention is directed to a counter-measure expendable load simulator that includes a handle, a spring, a hammer and test recording equipment. The spring communicates with the handle, while the hammer communicates with the handle such that when the handle is engaged, the handle and hammer compresses the spring, and when the handle is released the spring expands and the spring drives the hammer into a dummy expendable such that the dummy expendable is impacted by the hammer. Test recording equipment records loads imparted by the hammer on the dummy expendable.

It is a feature of the present invention to provide a counter-measure expendable load simulator that does not require pyrotechnics or aircraft flight. Furthermore, the testing can be conducted at a typical shop without special precautions or certification.

It is a feature of the present invention to provide a counter-measure expendable load simulator that allows easy re-configuration to simulate various types of physical load impulses.

It is a feature of the present invention to provide a counter-measure expendable load simulator that is simple in operation, easy to use, inexpensive and greatly reduces safety concerns.

It is a feature of the present invention to provide a counter-measure expendable load simulator that has simple construction, and is reliable with little breakdowns or failures.

### DRAWINGS

These and other features, aspects and advantages of the present invention will become better understood with reference to the following description and appended claims, and accompanying drawings wherein:

FIG. 1 is a perspective view of the counter-measure expendable load simulator with the spring expanded; and,

FIG. 2 is a perspective view of the counter-measure expendable load simulator with the spring compressed.

### DESCRIPTION

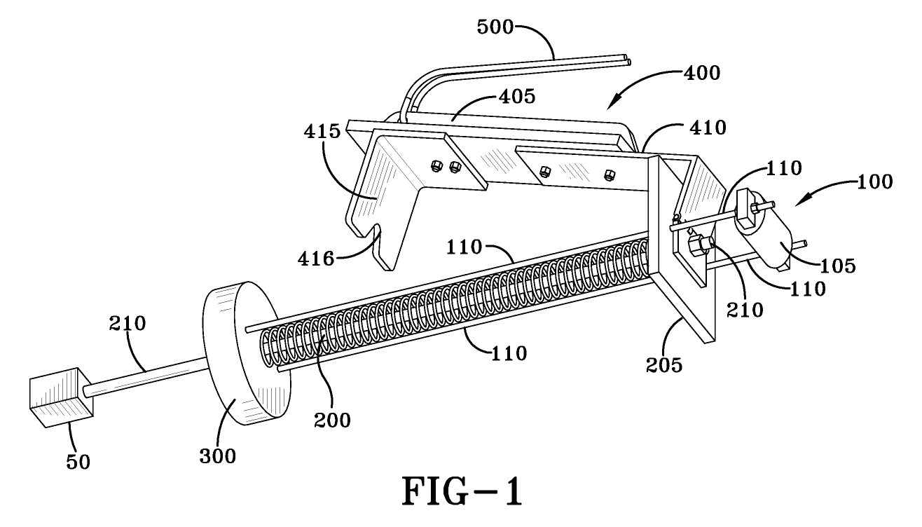

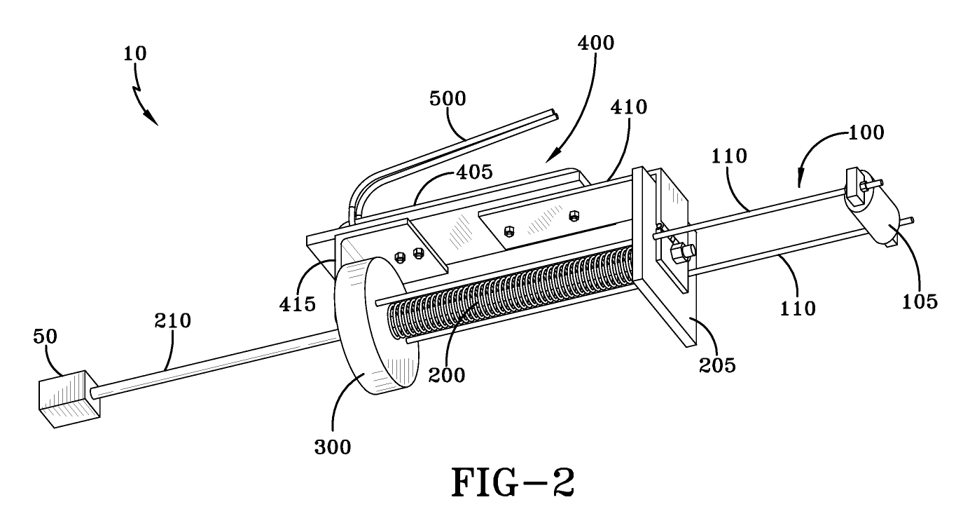

The preferred embodiments of the present invention are illustrated by way of example below and in FIGS. 1-2. As seen in FIG. 1, the counter-measure expendable load simulator 10 includes a handle 100, a spring 200, and a hammer 300. The hammer 300 communicates with the handle 100 such that when the handle 100 is engaged or pulled, the handle 100 and the hammer 300 compress the spring 200, and when the handle 100 is released the spring 200 expands and the spring 200 drives the hammer 300 into a dummy expendable 50 such that the dummy expendable 50 is impacted by the hammer 300.

In the description of the present invention, the invention will be discussed in an aircraft counter-measure environment; however, this invention can be utilized for any type of need that requires use of a load simulator.

The counter-measure expendable load simulator 10 may also include a hammer retainer 400 and a hammer retainer lanyard 500. The hammer retainer 400 communicates with the hammer 300 such that the hammer retainer 400 holds the hammer 300 in place when the handle is pulled and the spring 200 is compressed. The hammer retainer lanyard 500 communicates with the hammer retainer 400 such that when the hammer retainer lanyard 500 is pulled the hammer retainer 400 releases the hammer 300 such that the hammer 300 is moved by the expanding spring 200.

The handle 100 may include a handle cylinder 105 that is contoured for a human hand, as well as handle posts 110. The preferred embodiment includes two handle posts 110, as shown in FIG. 1, however, more or less handle posts 110 may be utilized. The handle posts 110 are attached to the handle cylinder 105 and the handle posts 110 extend from the handle cylinder 105 to the hammer 300. The handle cylinder 105 is attached to one end of each of the handles posts 110, while the other end of each handle post 110 is attached to the hammer 300. In the preferred embodiment of the invention, the handle posts 110 are substantially parallel, and each handle post 110 is substantially perpendicular to the handle cylinder 105. As shown in FIG. 1, when utilizing two handle posts 110, the handle posts 110 may be disposed on opposite ends of the handle cylinder 105.

The counter-measure expendable load simulator 10 may also include a spring plate 205 and a spring post 210. The spring post 210 may be disposed inside the spring 200 while still allowing the spring 200 to compress and expand (the spring post 210 has a smaller outer diameter than the inner diameter of the spring 200). The spring post 210 is attached to the spring plate 205 at one of its ends. The spring 200 is disposed between the hammer 200 and the spring plate 205. Each handle post 110 extends through the spring plate 205 such that the handle posts 110 can move in relation to the spring plate 205 with little or no frictional resistance. As shown in FIG. 2, the spring post 210 may extend through and past the hammer 300 such that a dummy expendable 50 can be placed on the spring post 210, specifically on the opposite end of the spring post 210 where the spring plate 205 is disposed. The hammer 300 can move along the spring post 210 with little or no frictional resistance.

As seen in FIGS. 1 and 2, the hammer 300 may be metal disc. The preferred hammer is manufactured from a steel alloy; however, any material that is deemed practicable may be used. As seen in FIG. 1, the hammer 300 may have an aperture in its center. The aperture may correspond to the spring post 210 such that the hammer 300 may move along the spring post 210 with little or no frictional resistance. In another embodiment of the invention, the frictional resistance may be configured to generate different loads or forces that are generated by the spring 200.

The hammer retainer 400 may include a hammer retainer main portion 405, a hammer retainer plate bracket 410 and a hammer retainer spring bracket 415. The hammer retainer plate bracket 410 and the hammer retainer spring bracket 415 may be right angle brackets as shown in FIG. 1. In the preferred embodiment, the hammer retainer main portion 405 is attached to the hammer retainer plate bracket 410 and the hammer retainer spring bracket 415. The hammer retainer plate bracket 410 is attached to the spring plate 205 such that the hammer retainer 400 may move rotatably. When engaged, the hammer retainer spring bracket 415 may keep the spring compressed. The hammer retainer spring bracket 415 may include a post notch 416 that corresponds to the spring post 210. As shown in FIG. 2, the hammer retainer spring bracket 415 may be placed behind the hammer 300 such that the hammer 300 keeps the spring 200 compressed.

In operation, a user may pull on the handle 100 specifically the handle cylinder 105, which causes the hammer 300 to move toward the spring plate 205 and compresses the spring 200. The hammer retainer 400 may then be pushed down, and as seen in FIG. 2, engage with the spring post 210 and hammer 300 on the opposite side of the hammer 300 where the spring 200 is disposed, specifically via the post notch 416. The hammer retainer 400 holds the hammer 300 in position to keep the spring 200 compressed. The hammer retainer lanyard 500 is then pulled, which causes the hammer retainer 400 to rotate about the hammer retainer plate bracket 410. As a result, the hammer 300 is no longer held in place by the hammer retainer spring bracket 415. The spring 200 then expands pushing the hammer 300 along the spring post 210 toward a dummy expendable 50. The dummy expendable 50 is then impacted by the hammer 300, and test equipment records loads imparted by the hammer 300 on the dummy expendable 50.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A counter-measure expendable load simulator, comprising:
a handle;
a spring; and,
a hammer, the hammer and handle communicating with the spring such that when the handle is pulled, the handle and the hammer compress the spring, and when the handle is released the spring is expanded and the spring drives the hammer into a dummy expendable such that the dummy expendable is impacted by the hammer.

2. The counter-measure expendable load simulator of claim 1, wherein the simulator further comprising of a hammer retainer that holds the hammer in place and keeps the spring compressed after the handle is pulled.

3. The counter-measure expendable load simulator of claim 2, wherein the simulator further comprises a hammer retainer lanyard, the hammer retainer lanyard communicating with the hammer retainer such that when the hammer retainer lanyard is pulled, the hammer retainer releases the hammer such that the hammer is moved by the expanding spring.

4. A counter-measure expendable load simulator, comprising:
a handle, the handle having a handle cylinder for grasping, a spring plate and at least one handle post, the handle post having a first end and a second end, the first end of the handle post attached to the handle cylinder;
a spring, the spring plate disposed between the handle cylinder and the spring;
a hammer, the second end of the handle post attached to the hammer, the hammer and the handle communicating with the spring such that when the handle is pulled, the hammer and the spring plate compresses the spring, and when the handle is released the spring is expanded and the spring drives the hammer into a dummy expendable such that the dummy expendable is impacted by the hammer;
a hammer retainer that holds the hammer in place and keeps the spring compressed after the handle is pulled; and.
a hammer retainer lanyard, the hammer retainer lanyard communicating with the hammer retainer such that when the hammer retainer lanyard is pulled, the hammer retainer releases the hammer such that the hammer is moved by the expanding spring.

5. The counter-measure expendable load simulator of claim 4, wherein the simulator further includes test equipment for recording loads imparted by the hammer on the dummy expendable.

6. The counter-measure expendable load simulator of claim 5, wherein the hammer retainer includes a hammer retainer main portion, a hammer retainer plate bracket and a hammer retainer spring bracket, the hammer retainer plate bracket is rotatably attached to the spring plate, the hammer retainer spring bracket is attached to one end of the hammer retainer main portion, while the hammer retainer plate bracket is attached to the other end of the hammer retainer main portion such that when engaged the hammer retainer spring bracket communicates with the hammer such that the hammer retainer keeps the hammer in place and the spring compressed.
